(19) United States
(12) Patent Application Publication
(10) Pub. No.: US 2008/0225892 A1
(43) Pub. Date: Sep. 18, 2008

(54) Using Forward Error Correction with Generic Stream Encapsulation in a Digital Broadcast Network

(75) Inventors: Jani Vare, Kaarina (FI); Jussi Vesma, Turku (FI); Harri J. Pekonen, Raisio (FI); Tommi Auranen, Turku (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/686,650

(22) Filed: Mar. 15, 2007

(51) Int. Cl. H04J 3/24

(52) U.S. Cl. 370/473

(57) ABSTRACT

Aspects of the invention are directed to using forward error correaction in a digital broadcast network that supports generic stream encapsulation. According to an embodiment, error correaction data is calculated over application data, and the application data and error correaction data are encapsulated in generic stream encapsulation packets. In another embodiment, error correaction data is calculated over generic stream encapsulation packets. In yet another embodiment, error correaction data is calculated over, and encapsulated within, generic stream encapsulation packets. In still another embodiment, error correaction data is calculated over application data packets.

### FIELD OF THE INVENTION

The invention relates generally to communications networks. More specifically, the invention relates to discovery of services, service transmission, and encapsulation in a communication network.

### BACKGROUND OF THE INVENTION

Digital broadband broadcast networks enable end users to receive digital content including video, audio, data, and so forth. Using a mobile terminal, a user may receive digital content over a wireless digital broadcast network. Digital content can be transmitted in a cell within a network. A cell may represent a geographical area that may be covered by a transmitter in a communication network. A network may have multiple cells and cells may be adjacent to other cells.

A receiver device, such as a mobile terminal, may receive a program or service in a data or transport stream. The transport stream carries individual elements of the program or service such as the audio and video components of a program or service. Typically, the receiver device locates the different components of a particular program or service in a data stream through Program Specific Information (PSI) or Service Information (SD embedded in the data stream. However, PSI or SI signaling may be insufficient in some wireless communications systems, such as Digital Video Broadcasting—Handheld (DVB-H) systems. Use of PSI or SI signaling in such systems may result in a sub-optimal end user experience as the PSI and SI tables carrying in PSI and SI information may have long repetition periods. In addition, PSI or SI signaling requires a large amount of bandwidth which is costly and also decreases efficiency of the system.

PSI/SI in ETSI EN 300 468 [V1.7.1 (2006-05)] Digital Video Broadcasting (DVB); Specification for Service Information (SI) in DVB systems, and U.S. application Ser. No. 11/443,317, entitled, Service Discovery Section, filed May 31, 2006 by Jani Vare et al. disclose conventional techniques for signaling service-discovery information.

MPEG-2 TS defines an encapsulation mechanism for data carried over DVB. Generic Stream Encapsulation (GSE) defines an encapsulation protocol for data carried over digital video broadcast specifications, such as DVB-S2, a second generation specification for Digital Video Broadcast—Satellite. The Generic Stream Encapsulation (GSE) protocol, which is under definition within the Generic Data Broadcasting & Service Information Protocols (GBS) group of DVB, provides an efficient means for encapsulating IP and other network layer packets over the generic Stream profile of the DVB-S2 physical layer.

GSE (Generic Stream Encapsulation), defined initially for DVB over Satellite (DVB-S2) ETSI EN 302 307 V1.1.2 (2006-06), entitled, Digital Video Broadcasting (DVB); Second generation framing structure, channel coding and modulation systems for Broadcasting, Interactive Services, News Gathering and other broadband satellite applications (downloadable at http://webapp.etsi.org/exchangefolder/en_{—}302307v010102p.pdf), is one of the possible candidates as an encapsulation protocol for digital broadband broadcast networks. However, currently there isn't any signaling supported within GSE in case Multi-protocol Encapsulation—Forward Error Correaction (MPE-FEC) type of Forward Error Correaction (FEC) mechanism (See ETSI EN 301 192 V1.4.1 (2004-11), entitled, Digital Video Broadcasting (DVB); DVB specification for data broadcasting) is used within next generation standards for Digital Video Broadcasting-Terrestrial/Handheld. Moreover, the transmission protocol beneath GSE will probably be different in next generation standards for Digital Video Broadcasting-Terrestrial/Handheld than the transmission protocol beneath GSE in DVB-S2.

As such, techniques for using forward error correaction in a digital broadcast network that supports generic stream encapsulation would advance the art.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Aspects of the invention are directed to using forward error correaction in a digital broadcast network that supports generic stream encapsulation. According to an embodiment, error correaction data is calculated over application data, and the application data and error correaction data are encapsulated in generic stream encapsulation packets which are further encapsulated in data stream protocol packets. In another embodiment, error correaction data is calculated over generic stream encapsulation packets, and error correaction data is encapsulated in generic stream encapsulation packets which are further encapsulated in data stream protocol packets. In yet another embodiment, error correaction data is calculated over, and encapsulated within, generic stream encapsulation packets. In still another embodiment, error correaction data is calculated over application data packets, application data is encapsulated within generic stream encapsulation packets, and error correaction data is encapsulated within data stream protocol packets.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a suitable digital broadband broadcast system in which one or more illustrative embodiments of the invention may be implemented.

FIG. 2 illustrates an example of a mobile device in accordance with an aspect of the present invention.

FIG. 3 illustrates an example of cells, each of which may be covered by a different transmitter in accordance with an aspect of the present invention.

FIG. 4 illustrates the OSI reference model as containing seven layers.

FIG. 5 shows an example of a syntax of a service discovery descriptor for providing parameters for service discovery in accordance with one or more aspects of the invention.

FIG. 6 shows an example of a syntax of a neighbouring service discovery descriptor in accordance with one or more aspects of the invention.

FIG. 7 shows an exemplary frame and slot structure in accordance with at least one aspect of the invention.

FIG. 8 shows exemplary mapping of services to logical channels and further to physical channels in accordance with one or more aspects of the invention.

FIG. 9 shows exemplary mapping of physical channels into time-division multiplexed slots in a modulator, in accordance with at least one aspect of the invention.

FIG. 10 illustrates an exemplary structure of a data stream protocol packet, in accordance with one or more aspects of the invention.

FIG. 11 shows an example of a Generic Stream Encapsulation header format.

FIG. 12 shows an example of a redefined label field of a Generic Stream Encapsulation header format in accordance with an aspect of the invention.

FIG. 13 shows an example of a redefined label field of a Generic Stream Encapsulation header format in accordance with a different aspect of the invention.

FIG. 14 is a flow chart showing steps of a first example of calculating RS data for a transmitted payload, in accordance with an aspect of the invention.

FIG. 15 is a flow chart showing steps of a second example of calculating RS data for a transmitted payload, in accordance with an aspect of the invention.

FIG. 16 is a flow chart showing steps of a third example of calculating RS data for a transmitted payload, in accordance with an aspect of the invention.

FIG. 17 is a flow chart showing steps of a fourth example of calculating Reed-Solomon (RS) data for a transmitted payload, in accordance with an aspect of the invention.

FIG. 18 shows Generic Stream Encapsulation (GSE) packets, RS parity data, and Data Stream Protocol (DSP) packets encoded in accordance with the example of FIG. 14.

FIG. 19 shows GSE packets, RS parity data, and DSP packets encoded in accordance with the example of FIG. 15.

FIG. 20 shows GSE packets and DSP packets encoded in accordance with the example of FIG. 16.

FIG. 21 shows GSE packets, RS parity data, and DSP packets encoded in accordance with the example of FIG. 17.

FIG. 22 shows steps performed by a receiver for processing received DSP packets of the type shown in FIGS. 18 and 21, in accordance with one or more aspects of the invention.

FIG. 23 shows steps performed by a receiver for processing received DSP packets of the type shown in FIG. 19, in accordance with one or more aspects of the invention.

FIG. 24 shows steps performed by a receiver for processing received DSP packets of the type shown in FIG. 20, in accordance with one or more aspects of the invention.

FIG. 25 is a schematic diagram of a transmitter in accordance with aspects of the invention.

FIG. 26 is a schematic diagram of a transmitter in accordance with aspects of the invention.

FIG. 27 is a schematic diagram of a a receiver in accordance with aspects of the invention.

FIG. 28 is a schematic diagram of a receiver in accordance with aspects of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

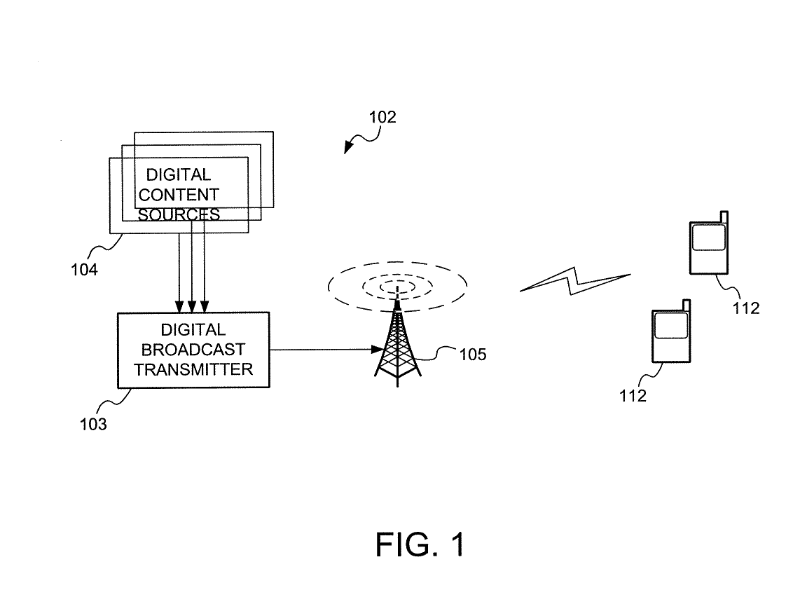

FIG. 1 illustrates a suitable digital broadband broadcast system 102 in which one or more illustrative embodiments may be implemented. Systems such as the one illustrated here may utilize a digital broadband broadcast technology, for example Digital Video Broadcast—Handheld (DVB-H) or next generation DVB-H networks.

Examples of other digital broadcast standards which digital broadband broadcast system 102 may utilize include Digital Video Broadcast—Terrestrial (DVB-T), Integrated Services Digital Broadcasting—Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Satellite Digital Multimedia Broadcasting (S-DMB), Forward Link Only (FLO), Digital Audio Broadcasting (DAB), and Digital Radio Mondiale (DRM). Other digital broadcasting standards and techniques, now known or later developed, may also be used. Aspects of the invention may also be applicable to other multicarrier digital broadcast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

Digital content may be created and/or provided by digital content sources 104 and may include video signals, audio signals, data, and so forth. Digital content sources 104 may provide content to digital broadcast transmitter 103 in the form of digital packets, e.g., Internet Protocol (IP) packets. A group of related IP packets sharing a certain unique IP address or other source identifier is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission component) for wireless transmission. Ultimately, mobile terminals or devices 112 may selectively receive and consume digital content originating from digital content sources 104.

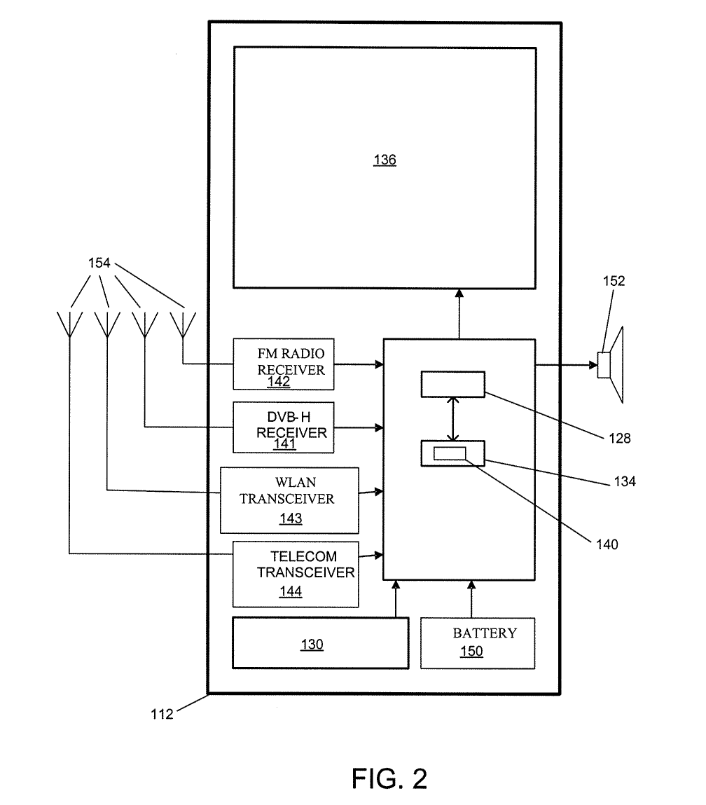

As shown in FIG. 2, mobile device 112 may include processor 128 connected to user interface 130, memory 134 and/or other storage, and display 136, which may be used for displaying video content, service guide information, and the like to a mobile-device user. Mobile device 112 may also include battery 150, speaker 152 and antennas 154. User interface 130 may further include a keypad, touch screen, voice interface, one or more arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H or DVB-T, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-Satellite (DVB-S), or DVB-Terrestrial (DVB-T). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting—Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing entails sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

In addition, an electronic service guide may be used to provide program or service related information. Generally, an Electronic Service Guide (ESG) enables a terminal to communicate what services are available to end users and how the services may be accessed. The ESG includes independently existing pieces of ESG fragments. Traditionally, ESG fragments include XML and/or binary documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data including the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One type of DVB is Digital Video Broadcasting-Handheld (DVB-H). The DVB-H is designed to deliver 10 Mbps of data to a battery-powered terminal device.

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, is incorporated into the TS. This enables a receiver device to correctly process the data contained within the TS.

As stated above, the ESG fragments may be transported by IPDC over a network, such as for example, DVB-H to destination devices. The DVB-H may include, for example, separate audio, video and data streams. The destination device must then again determine the ordering of the ESG fragments and assemble them into useful information.

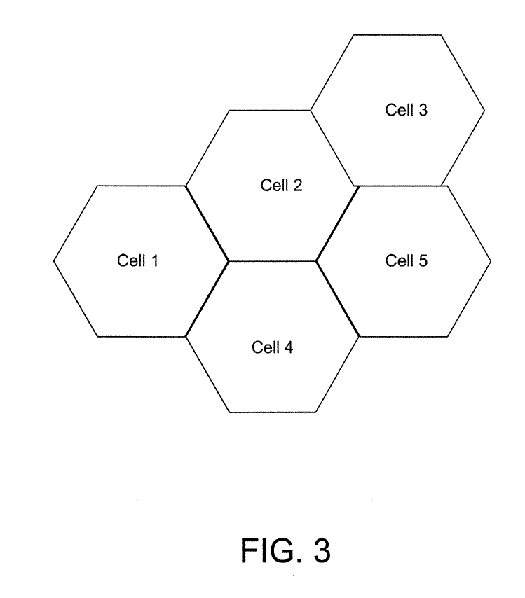

In a typical communication system, a cell may define a geographical area that may be covered by a transmitter. The cell may be of any size and may have neighboring cells. FIG. 3 illustrates schematically an example of cells, each of which may be covered by a different transmitter. In this example, Cell 1 represents a geographical area that is covered by a transmitter for a communication network. Cell 2 is next to Cell 1 and represents a second geographical area that may be covered by a different transmitter. Cell 2 may, for example, be a different cell within the same network as Cell 1. Alternatively, Cell 2 may be in a network different from that of Cell 1. Cells 1, 3, 4, and 5 are neighboring cells of Cell 2, in this example.

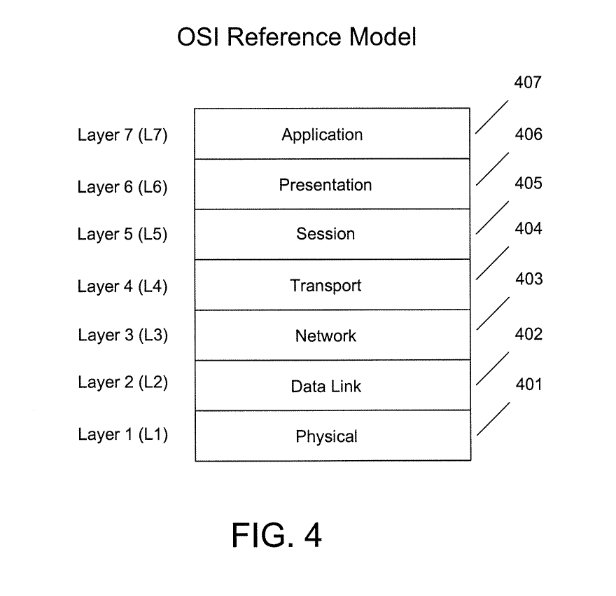

Communication between network components may be accomplished via the Open Systems Interconnection (OSI) standard. The OSI framework of the process for communication between different network components may be structured as seven layers or categories as described by the OSI reference model. FIG. 4 illustrates the OSI reference model as containing seven layers. Typically, layers 4-7 pertain to end-to-end communications between message source and message destination and layers 1-3 pertain to network access. Layer 1 (401, the physical layer) deals with the physical means of sending data over lines. This may include, for example, electrical, mechanical or functional control of data circuits. Layer 2 (402, the data link layer) pertains to procedures and protocols for operating communication lines. Also, detection and correaction of message errors may be accomplished in Layer 2. Layer 3 (403, network layer) determines how data is transferred between different network components. Also, Layer 3 (403) may address routing in networks. Layer 4 (404, Transport layer) pertains to defining rules for information exchange. Layer 4 (404) may also be involved in the end-to-end delivery of information within and between networks. This information may further include error recovery and flow control. Layer 5 (405, Session layer) pertains to dialog management in Layer 5 (405) and may control use of basic communications facilities provided by Layer 4 (404, transport layer). Layer 6 (406, presentation layer) pertains to providing compatible interactivity between data formats. Layer 7 (407, application layer) provides functions for particular applications services. These functions may include file transfer, remote file access and/or virtual terminals.

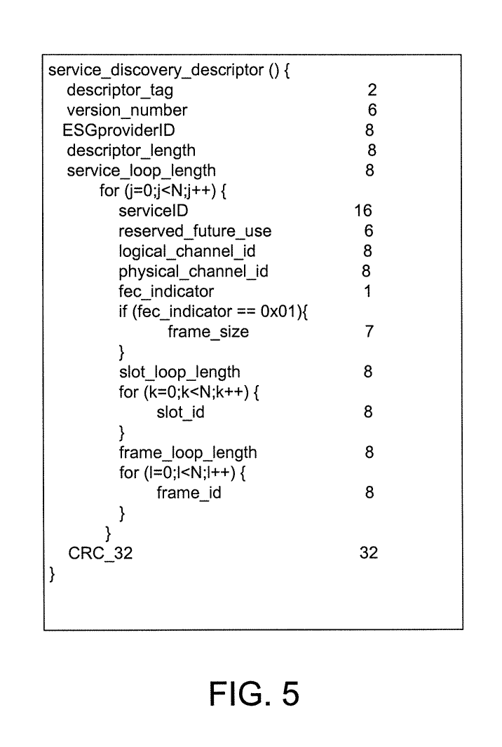

FIG. 5 shows an example of a syntax of a service discovery descriptor for providing parameters for service discovery in accordance with one or more aspects of the invention. In the example the notation follows ETSI EN 300 468. Such a service discovery descriptor may be specific to an Electronic-Service-Guide (ESG) provider and/or a particular cell and may provide a mapping between a service identifier (e.g., serviceID), a logical channel identifier (e.g., logical-channel_id), and a physical channel identifier (e.g., physical_channel_id). FIG. 5 shows the fields of the example service discovery descriptor in a left-hand column and the size in bits of those fields in a right-hand column.

Referring to FIG. 5, a descriptor tag parameter (e.g., descriptor_tag) may be used for indicating the type of the service discovery descriptor. For example, a value of 0x01 could indicate that the service-discovery_descriptor is a service_discovery_descriptor, as opposed to a different type of descriptor.

A version number (e.g., version_number) may be used for indicating a version of the service discovery descriptor. The version number field may be used by a terminal to detect whether there are any changes within the service discovery descriptor since the terminal previously examined the service discovery descriptor.

An ESG provider identifier (e.g., ESGproviderID) may be used for identifying an ESG provider of the services announced within the service discovery descriptor. In accordance with one or more aspects of the invention, services listed within a particular service discovery descriptor may be unique within an associated ESG provider identifier.

A service loop length, (e.g., service_loop_length) may be used for indicating a length of the loop that is located in the example service discovery descriptor between service_loop_length and CRC_{—}32.

A service identifier (e.g., serviceID) may be used for uniquely identifying a service within the scope of an ESG provider (e.g., that of defined in Digital Video Broadcasting Convergence of Broadcast and Mobile Services (DVB-CBMS) or Open Mobile Alliance Mobile Broadcast Services (OMA BCAST)). A service identifier may be associated with one or more Internet Protocol (IP) streams (each of which may be identified by a respective IP address).

A logical channel identifier (e.g., logical channel_id) may be used for providing a one-to-one mapping with the service identifier (i.e. serviceID) and ESG provider identifier (i.e. ESGProviderID) pair. The logical channel identifier may identify the logical channel of the associated service identifier. The logical channel identifier may be used by the receiver for discovering a packet's portion of a specific logical channel in case there are packets from more than one logical channel available within a particular physical channel.

A physical channel identifier (e.g., physical_channel_id) may be used to identify a physical channel where an associated logical channel is carried.

An FEC (Forward Error Correaction) indicator (e.g., fec_indicator) may be used for indicating whether or not FEC is used for an associated service. In one example, if the FEC indicator has been set to 0x01, then FEC is used for the associated service.

A frame size (e.g., frame_size) may be used to indicate a FEC frame size in case FEC is supported with the associated service.

A slot loop length (e.g., slot_loop_length) may be used for indicating a length of the loop that is located in the example service discovery descriptor between slot_loop_length and frame_loop_length. In accordance with at least one aspect of the invention, each slot loop iteration corresponds with a particular iteration within a frame loop.

A slot identifier (e.g., slot_id) may be used for identifying a slot in which an associated service is carried. A particular service may be carried within multiple slots, which are located within one or more frames.

A frame loop length (e.g., frame_loop_length) may be used for indicating a length of the loop that is located in the example service discovery descriptor between frame_loop_length and CRC_{—}32. In accordance with at least one aspect of the invention, each frame loop iteration corresponds with a particular iteration within a particular slot loop.

A frame identifier (e.g., frame_id) may be use for identifying a particular frame. In accordance with at least one aspect of the invention, each frame may be associated with one or more slots.

The service discovery descriptor may further comprise a cyclic redundancy check code, in this example a 32 bit field CRC_{—}32 as presented in ETSI EN 300 468. The service discovery descriptor may further comprise one or more fields of different lengths for future use (e.g., reserved_future_use).

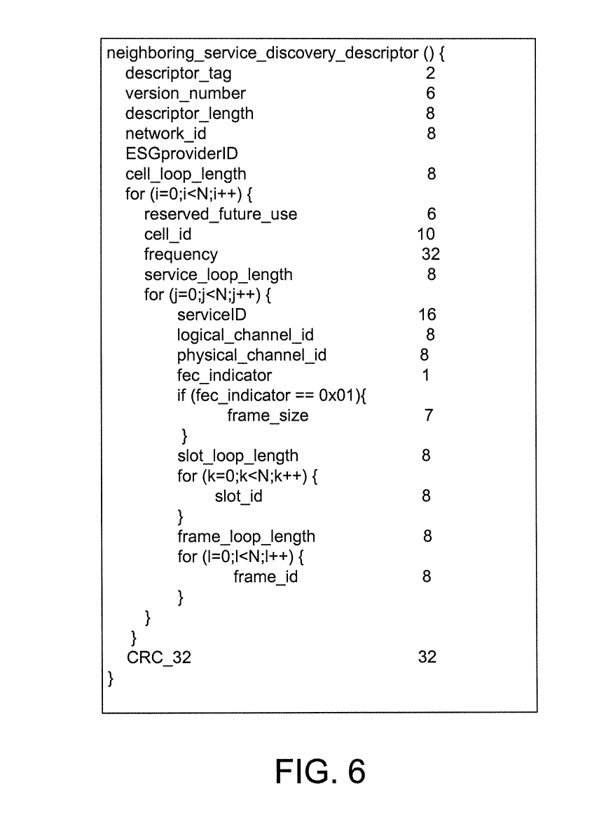

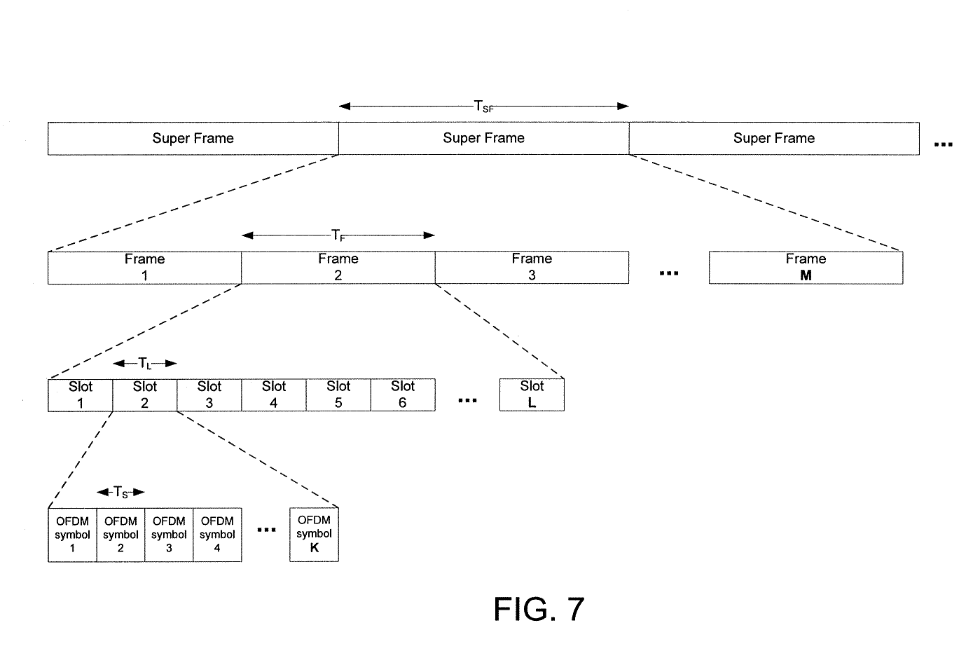

FIG. 6 shows an example of a syntax of a neighboring service discovery descriptor (e.g., neighboring_service_discovery_descriptor) in accordance with one or more aspects of the invention. Such a neighboring service discovery descriptor may include a frame identifier (e.g., frame_id) and a slot identifier (e.g., slot_id), and each physical channel may have one or more slots within one or more frames. An example of the frame and slot structure is shown in FIG. 7.

A neighbouring service discovery descriptor in accordance with at least one aspect of the invention may provide mapping for the services available within neighbouring cells.

In accordance with the example neighbouring service discovery descriptor of FIG. 6, a single descriptor may be provided per network. According to one or more aspects of the invention, an alternative version of the same descriptor could have information for multiple networks carried within a single descriptor. FIG. 6 shows the fields of the example neighboring service discovery descriptor in a left-hand column and the size in bits of those fields in a right-hand column.

Referring to FIG. 6, a descriptor tag parameter (e.g., descriptor_tag) may be used for indicating the type of the neighboring service discovery descriptor. For example, a value of 0x02 could indicate that the neighboring_service_discovery_descriptor is a neighboring_service_discovery_descriptor, as opposed to a different type of descriptor.

A version number (e.g., version_number) may be used for indicating a version of the service discovery descriptor. The version number field may be used by a terminal to detect whether there are any changes within the neighboring service discovery descriptor since the terminal previously examined the neighboring service discovery descriptor.

A network identifier (e.g., network_id) may be used for indicating a network of the elements described within the neighboring service discovery descriptor.

An ESG provider identifier (e.g., ESGproviderID) may be used for identifying an ESG provider of the services announced within the neighboring service discovery descriptor. In accordance with one or more aspects of the invention, services listed within a particular neighboring service discovery descriptor may be unique within an associated ESG provider identifier. Hence, two serviceIDs with the same value may be mutually distinguished based on ESGproviderID.

A cell loop length (e.g., cell_loop length) may be used to indicate a length of the cell loop, which appears in the example neighboring service discovery descriptor between cell_loop_length and CRC_{—}32.

A cell identifier (e.g., cell_id) may be used for identifying a cell. In accordance with at least one aspect of the invention, each cell may be unique within one network.

A frequency field (e.g., frequency) may be used for indicating a frequency of the signal covering an area of the associated cell. The indicated frequency may be the channel center frequency.

A service loop length, (e.g., service_loop_length) may be used for indicating a length of the loop that is located in the example neighboring service discovery descriptor between service_loop_length and CRC_{—}32.

A service identifier (e.g., serviceID) may be used for uniquely identifying a service within the scope of an ESG provider (e.g., that of defined in DVB-CBMS or OMA BCAST). A service identifier may be associated with one or more Internet Protocol (IP) streams (each of which may be identified by a respective IP address).

A logical channel identifier (e.g., logical channel_id) may be used for providing a one-to-one mapping with the service identifier. The logical channel identifier may identify the logical channel of the associated service identifier. The logical channel identifier may be used by the receiver for discovering a packet's portion of a specific logical channel in case there are packets from more than one logical channel available within a particular physical channel.

A physical channel identifier (e.g., physical_channel_id) may be used to identify a physical channel where an associated logical channel is carried.

An FEC (Forward Error Correaction) indicator (e.g., fec_indicator) may be used for indicating whether or not FEC is used for an associated service. In one example, if the FEC indicator has been set to 0x01, then FEC is used for the associated service.

A frame size (e.g., frame_size) may be used to indicate a FEC frame size in case FEC is supported with the associated service.

A slot loop length (e.g., slot_loop_length) may be used for indicating a length of the loop that is located in the example neighboring service discovery descriptor between slot_loop_length and frame_loop_length. In accordance with at least one aspect of the invention, each slot loop iteration corresponds with a particular iteration within a frame loop.

A slot identifier (e.g., slot_id) may be used for identifying a slot in which an associated service is carried. A particular service may be carried within multiple slots, which are located within one or more frames.

A frame loop length (e.g., frame_loop_length) may be used for indicating a length of the loop that is located in the example neighboring service discovery descriptor between frame_loop_length and CRC_{—}32. In accordance with at least one aspect of the invention, each frame loop iteration corresponds with a particular iteration within a particular slot loop.

A frame identifier (e.g., frame_id) may be use for identifying a particular frame. In accordance with at least one aspect of the invention, each frame may be associated with one or more slots.

The service discovery descriptor may further comprise a cyclic redundancy check code, in this example a 32 bit field CRC_{—}32 as presented in ETSI EN 300 468. The service discovery descriptor may further comprise one or more fields of different lengths for future use (e.g., reserved_future_use).

FIG. 7 shows an example frame and slot structure in accordance with at least one aspect of the invention. According to the example, the durations of a superframe T_{SF}, frame T_{F}, slot T_{L}, and symbol T_{S} are fixed for one network configuration. All these may be configurable. If FFT mode is changed the symbol time T_{S} changes correspondingly, e.g. if FFT size is changed from 2K to 8K, then the symbol time T_{S} would be multiplied by four. Slot time T_{L} can remain unchanged by changing K, the number of Orthogonal Frequency Division Multiplexing (OFDM) symbols within one slot. In the previous exemplary case, when FFT size is changed from 2K to 8K, the number of OFDM symbols in the slot K would be divided by four. A slot forms one (or an integer number of) interleaving block(s) (time interleaving). Slot size (in bits) determines the size of the interleaving block (or its integer fraction).

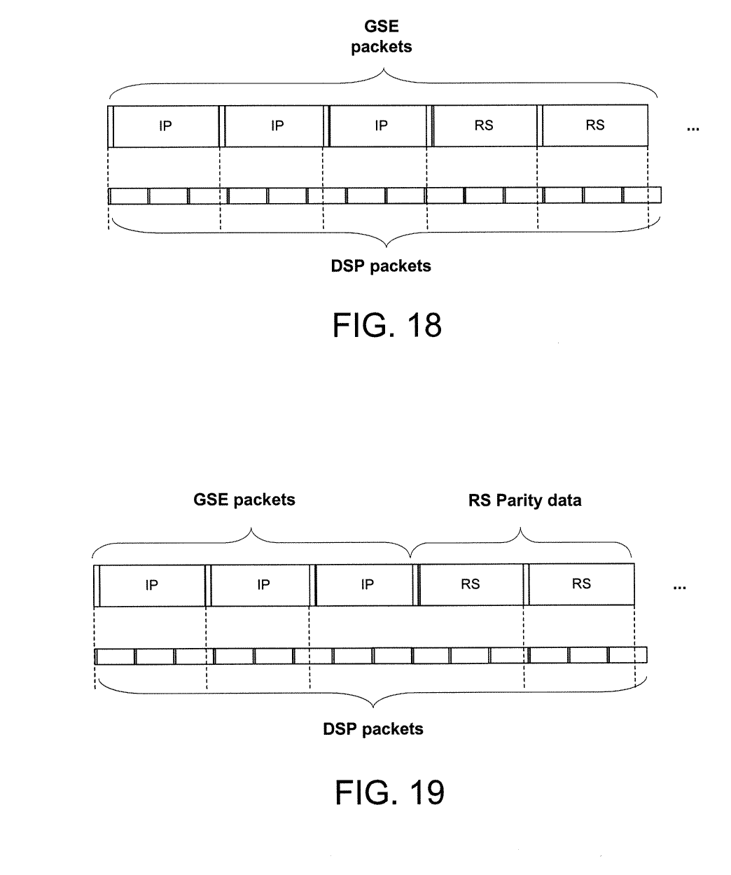

A physical channel (e.g., PHY_channel) may be determined as follows: slot_no={s₁, s₂, s₃ . . . , s_{R}}, where 1≦R≦L; and frame_no={f₁, f₂, f₃ . . . , f_{P}}, where 1≦P≦M. Thus, in the example of FIG. 7, each physical channel has at least one slot in one super frame. For example, slot_no={4} and frame_no={1}, means that PHY_channel has one slot (no. 4) in one frame (no.1) during each super frame. As another example, slot_no={4} and frame_no={1, 2, 3, . . . , M}, means that PHY_channel has one slot (no. 4) in each frame during each super frame. Various aspects of the physical channel are discussed in more detail below in connection with FIGS. 18 and 19.

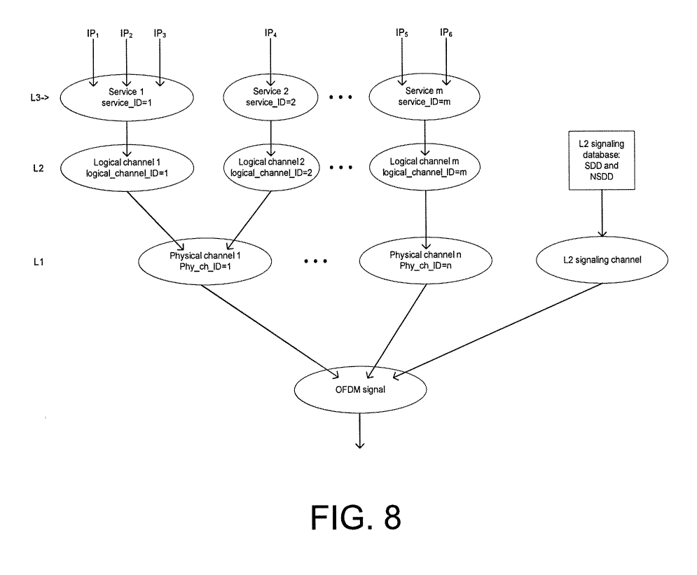

FIG. 8 shows mapping of services to logical channels and further to physical channels in accordance with one or more aspects of the invention. Service to logical channel mapping is a one-to-one mapping. A physical channel can carry one or more logical channels.

One service may include one or more IP streams. Each service may have a unique service identifier. This service identifier and the corresponding IP addresses may be listed in ESG data. In data link layer (L2), the services are mapped into the logical channels. This is one-to-one mapping, and the service identifier uniquely determines the logical channel identifier. L2 signaling may have a dedicated signaling channel in the physical layer.

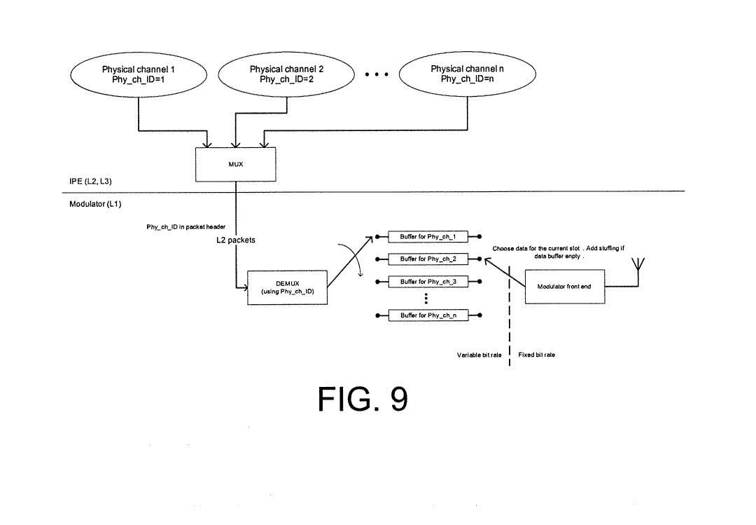

FIG. 9 shows mapping of physical channels into time-division multiplexed slots in a modulator, in accordance with at least one aspect of the invention.

Logical channels are mapped into the physical channels as shown in FIG. 8. One physical channel can carry one or more logical channels, but one logical channel can not be divided between multiple physical channels.

Physical channels are L1 layer time division multiplexing (TDM) channels each having a dedicated time slot in the OFDM signal. One physical channel reserves the OFDM transmission capacity during the slot. There may be a fixed integer number of OFDM symbols in each slot. The idea of the physical channel can be extended in such a way that instead of reserving one slot it can reserve multiple slots.

Physical channels can have dedicated Quality of Service (QoS) parameters including, but not limited to, code rate, modulation, average bit rate (depends on the slot interval and size), access delay (depends on the slot interval), power saving (depends on the slot duration and interval), and the like.

FIG. 9 shows an example implementation for the mapping of the physical channels into TDM slots. In Internet Protocol Encapsulator (IPE), the physical channels are multiplexed into a stream of L2 packets. In the modulator, there is a buffer for each physical channel, and L2 packets are written into the corresponding buffer according to Phy_ch_id. The front end of the modulator then forms a TDM slot by selecting data from one physical channel buffer. The selection may be performed according to the parameters defining the physical channel-to-slot mapping.

L2 packets are not sent to the modulator with a fixed clock rate specified by the modulator bit rate as is done in the DVB-T transport stream. Therefore, buffers are needed as an interface between the variable and the fixed bit rate parts of the modulator.

An alternative is to move buffers and some other functionality of the modulator to the IPE. In this case, the IPE forms the TDM slots and sends them to the modulator with a fixed clock rate.

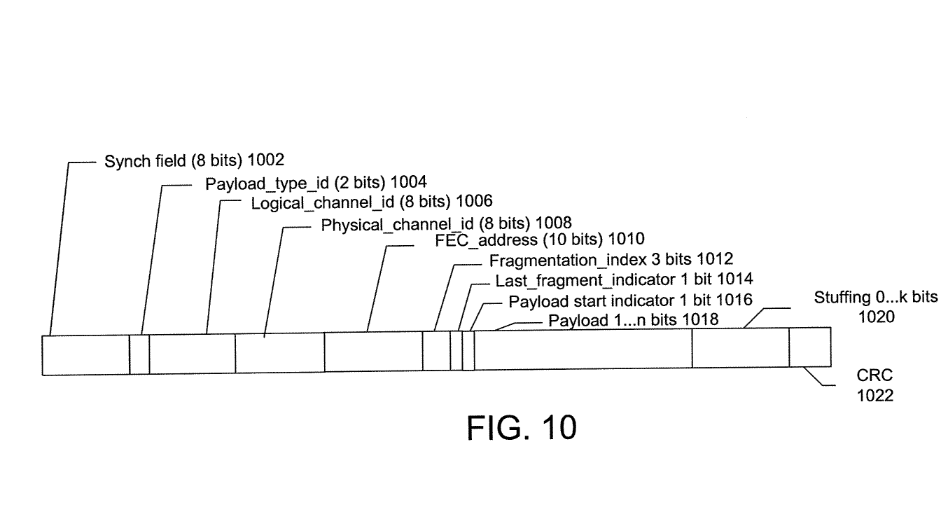

FIG. 10 illustrates an exemplary structure of a DSP packet, in accordance with one or more aspects of the invention.

Synchronization field 1002 enables detection of the beginning of each DSP packet within a receiver and a network. In accordance with at least one aspect of the invention, synchronization field contains 8 bits. As is the case with other fields and parameters disclosed herein having a particular number of bits, the synchronization field may contain any other suitable number of bits. In various embodiments of the invention the DSP packet may have additional fields and one or more of the exemplary fields may be omitted or combined with each other.

Payload type identifier 1004 (e.g., payload_type_id) may be used for identifying the payload type encapsulated within the payload. For example, payload type identifier may specify a payload type including, but not limited service discovery descriptor, (SDD), neighboring service discovery descriptor (NSDD), Internet Protocol (IP), Reed-Solomon (RS) and the like.

Logical channel identifier 1006 (e.g., logical channel_id) may be used for identifying a logical channel of an associated packet. This identifier may be used by a receiver for discovering the packets part of specific logical channel when there are packets from more than one logical channel available within a particular slot.

Physical channel identifier 1008 (e.g., physical_channel_id) may be used for identifying a physical channel in which an associated DS packet is carried. A physical channel identifier enables a network element to allocate DSP packets into correct physical channels.

Forward Error Correaction address 1010 (e.g., FEC_address) may be used for mapping DS packets carrying application data with corresponding DS packets carrying RS data when FEC is used. If FEC is not used, this field can be ignored.

Fragmentation index 1012 (e.g., Fragmentation_index) is a counter for the payload fragments encapsulated within DSP packets. Fragmentation index 1012 enables a receiver to decapsulate the payload in the correct order, e.g., in case some of the packets are lost.

Last fragment indicator 1014 (e.g., last_fragment_indicator) may be used for indicating a last fragment of an encapsulated payload.

Payload start indicator 1016 (e.g., Payload_start_indicator) may be used for indicating whether a current DSP packet carries the first fragment of an encapsulated payload. Payload 1516 is the payload of a DSP packet.

Stuffing 1020 are bits that may be added if a packet is not full. And Cyclic Redundancy Check (CRC) 1022 is a well known way for checking that a received block of data is free from errors.

In accordance with at least one aspect of the invention, DSP packets have a fixed size. The size of the packet may be determined based on an error correaction code, the length of the interleaver, and the length of a symbol.

In accordance with an aspect of the invention, a Multi-Protocol Encapsulation Forward Error Correaction (MPE-FEC) type of FEC mechanism may be used with Generic Stream Encapsulation (GSE).

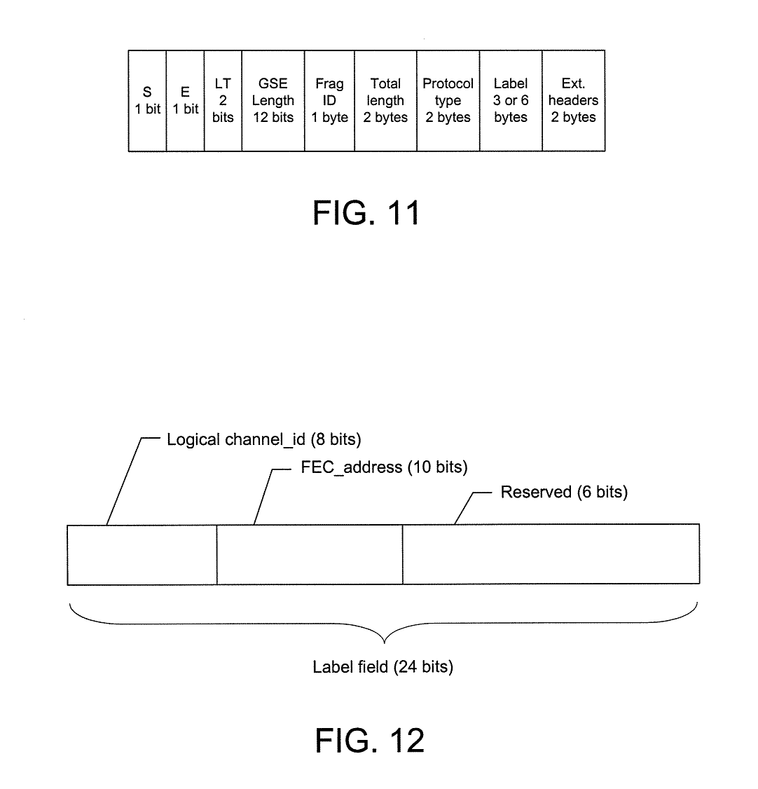

An exemplary Generic Stream Encapsulation header format is shown in FIG. 11. S is one bit “Start flag,” E is a one bit “End flag,” and LT is a two bit field “Label type” (or “Label format”).

In accordance with an aspect of the invention, label fields may be redefined. If GSE is used, then the 3 byte label field may be used as follows. LT field is set to value “01” indicating that the 3 byte label field is used, if the associated logical channel supports MPE-FEC, which may be signalled, e.g., in Service Discovery Descriptor (SDD) and/or Neighbouring Service Discovery Descriptor (NSDD), as discussed above.

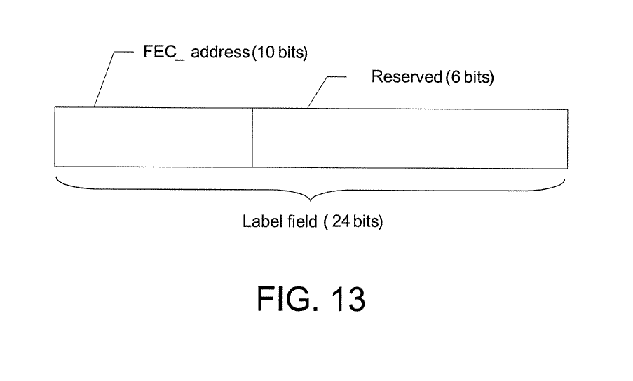

In an embodiment, which is shown in FIG. 12, a logical channel identifier (e.g., logical_channel_id) is signalled within a GSE header, and in a second embodiment, which is shown in FIG. 13, a logical channel identifier is signalled within the lower protocol layer encapsulation header (in Data Stream Protocol (DSP) header field).

The logical channel identifier may be used for identifying a logical channel of the associated packet. The receiver may use this identifier for discovering which services are carried on which GSE packets, in case there are services from multiple logical channels within a particular physical channel. In such a case, the logical channel identifier is not signaled within a lower layer encapsulation protocol.

If FEC is used, then the FEC address may be used for mapping: DS packets carrying application data with corresponding DS packets carrying RS data. Application data may be composed of application data carrying datagrams, e.g. in the form of IP datagrams or other data, such as signaling metadata. If FEC is not used, the FEC address may be ignored.

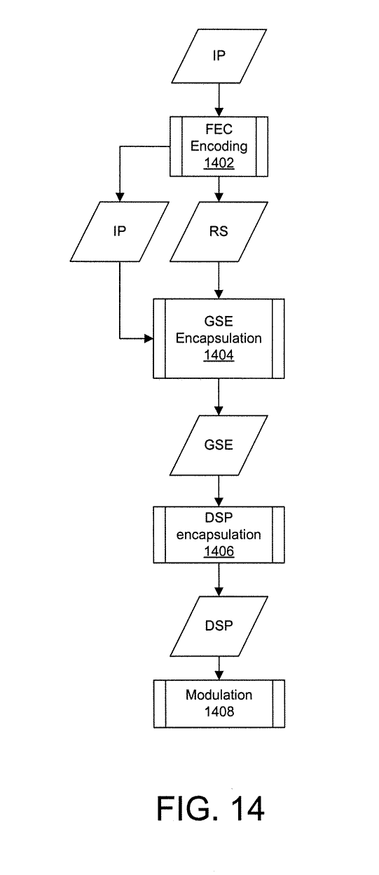

RS data for a transmitted payload (e.g., IP) may be calculated in multiple ways. A first example for calculating RS data for a transmitted payload, in accordance with one or more aspects of the invention, is shown in FIG. 14. FEC encoding is performed on IP data to calculate the RS parity data and provides IP datagrams and RS data as output, as shown at 1402. GSE encapsulation is performed to encapsulate IP data and RS data into separate GSE packets, as shown at 1404. DSP encapsulation is performed to encapsulate GSE packets into DSP packets, as shown at 1406. And modulation is performed to schedule the DSP packets into transmission frame slots, as shown at 1408.

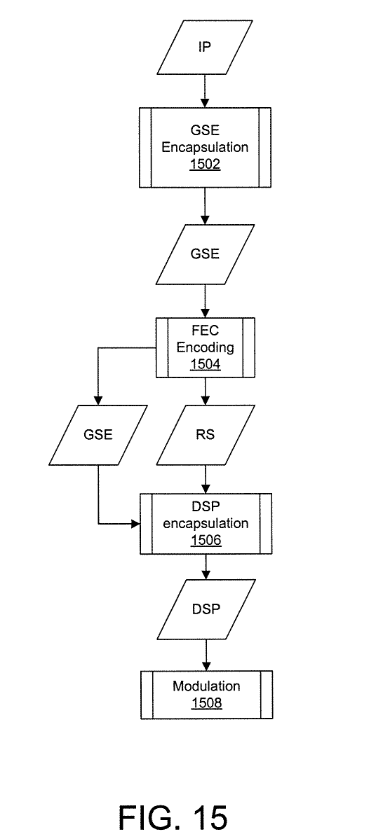

A second example for calculating RS data for a transmitted payload, in accordance with one or more aspects of the invention, is shown in FIG. 15. GSE encapsulation is performed to encapsulate IP data into separate GSE packets, as shown at 1502. FEC encoding is performed to calculate RS parity data and to provide GSE packets and RS data as shown at 1504. DSP encapsulation is performed to encapsulate GSE packets and RS data into DSP packets, as shown at 1506. And modulation is performed to schedule the DSP packets into transmission frame slots, as shown at 1508.

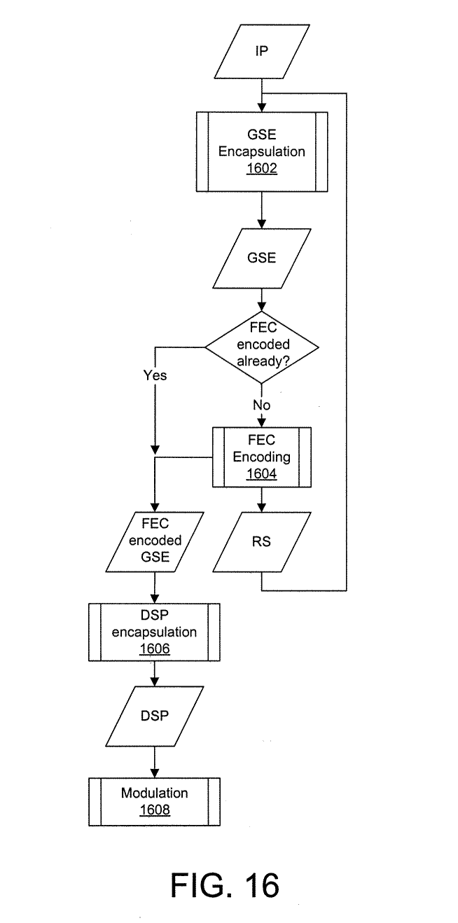

A third example for calculating RS data for a transmitted payload, in accordance with one or more aspects of the invention, is shown in FIG. 16. GSE encapsulation is performed to encapsulate IP data and RS data into separate GSE packets, as shown at 1602. If FEC encoding has not already been performed for the GSE packets, then FEC encoding is performed to calculate RS parity data and to provide FEC encoded packets for DSP encapsulation and RS data for GSE encapsulation, as shown at 1604. DSP encapsulation is performed to encapsulate FEC encoded GSE packets into DSP packets, as shown at 1606. And modulation is performed to schedule the DSP packets into transmission frame slots.

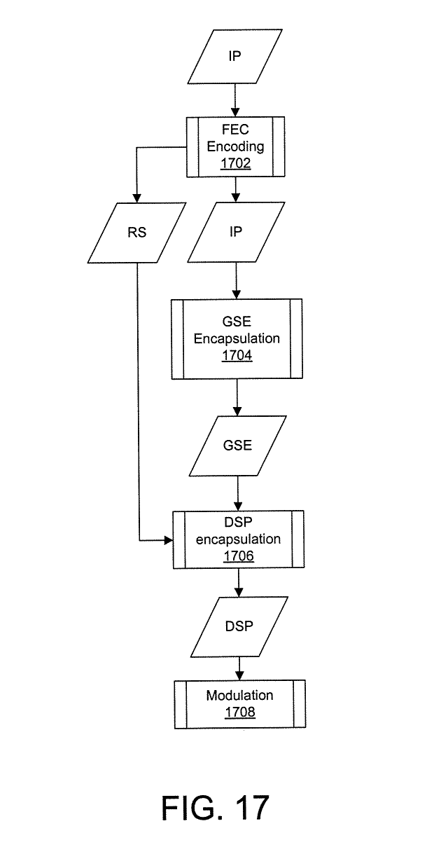

A fourth example for calculating RS data for a transmitted payload, in accordance with one or more aspects of the invention, is shown in FIG. 17. FEC encoding is performed to calculate RS parity data and to provide IP datagrams and RS data, as shown at 1702. GSE encapsulation is performed to encapsulate IP data into GSE packets, as shown at 1704. DSP encapsulation is performed to encapsulate GSE packets and RS data into DSP packets, as shown at 1706. And modulation is performed to schedule the DSP packets into transmission frame slots.

FIG. 18 shows GSE packets and DSP packets encoded in accordance with the example of FIG. 14. In FIG. 18, RS data is calculated over application data.

FIG. 19 shows GSE packets, RS parity data, and DSP packets encoded in accordance with the example of FIG. 15. In FIG. 19, RS data is calculated over GSE packets.

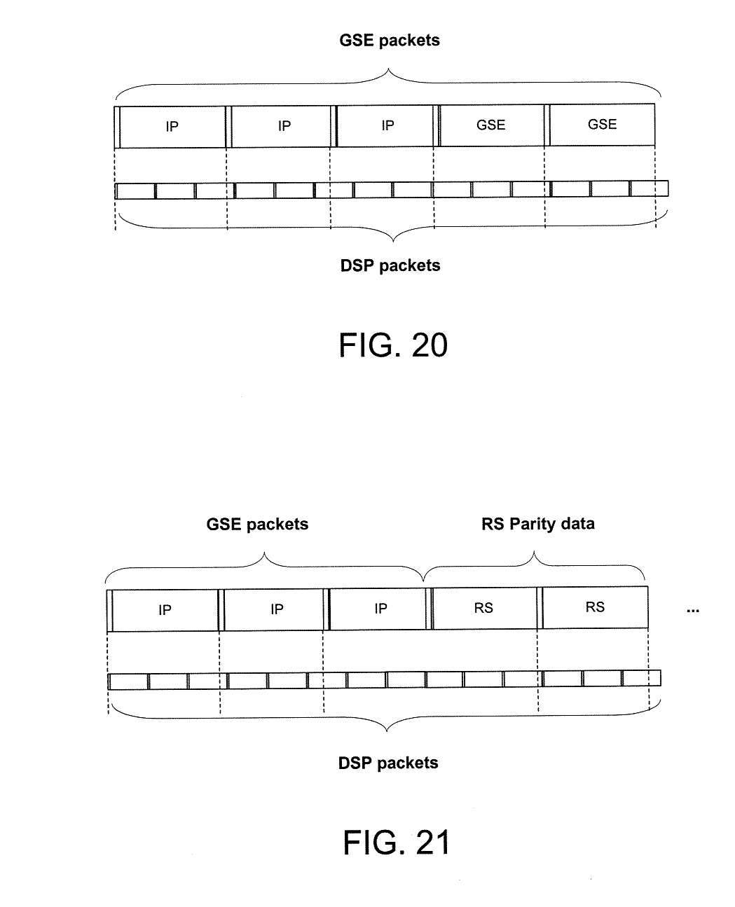

FIG. 20 shows GSE packets and DSP packets encoded in accordance with the example of FIG. 16. In FIG. 20, GSE packets have RS parity data encapsulated.

FIG. 21 shows GSE packets, RS parity data, and DSP packets encoded in accordance with the example of FIG. 17. In FIG. 21, RS data is calculated over application data packets.

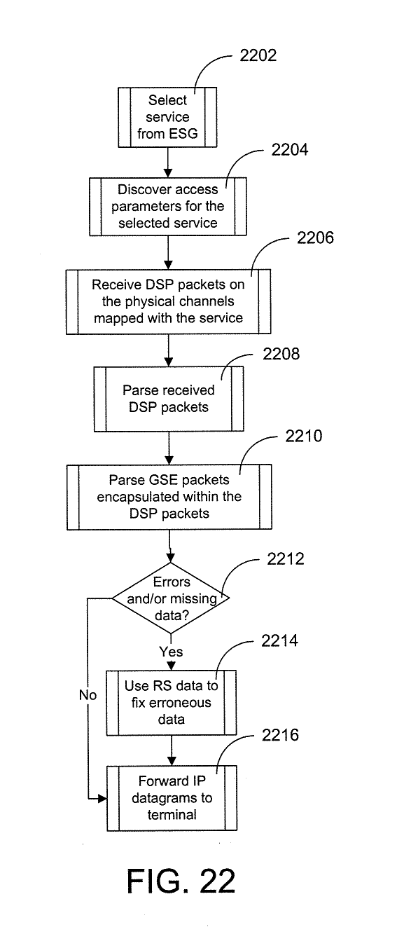

FIG. 22 shows steps performed by a receiver for processing received DSP packets of the type shown in FIGS. 18 and 21, in accordance with one or more aspects of the invention. A service is selected from an ESG, as shown at 2202. Access parameters, such as access parameters of an SDD and/or an NSDD, for the selected service are discovered, as shown at 2204. DSP packets are received on the physical channels mapped with the service, as shown at 2206. The received DSP packets are parsed, as shown at 2208. GSE packets encapsulated within the DSP packets are parsed, as shown at 2210. If there are no errors and/or missing data, then the “no” branch from 2212 will be followed and IP datagrams will be forwarded to a terminal, as shown at 2216. Otherwise, if there are one or more errors and/or missing data, then the “yes” branch from 2212 will be followed, the RS data will be used to fix the erroneous and/or missing data, as shown at 2214, and IP datagrams will be forwarded to a terminal, as shown at 2216.

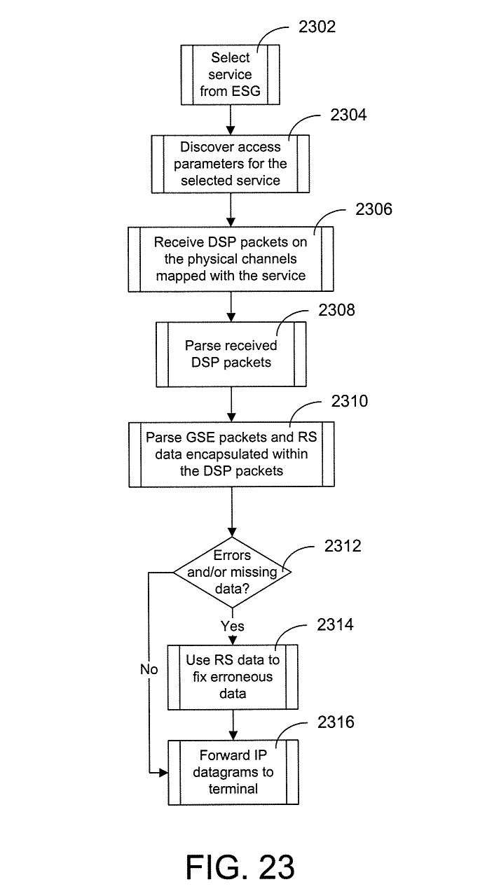

FIG. 23 shows steps performed by a receiver for processing received DSP packets of the type shown in FIG. 19, in accordance with one or more aspects of the invention. A service is selected from an ESG, as shown at 2302. Access parameters, such as access parameters of an SDD and/or an NSDD, for the selected service are discovered, as shown at 2304. DSP packets are received on the physical channels mapped with the service, as shown at 2306. The received DSP packets are parsed, as shown at 2308. GSE packets with matching logical channel identifiers and RS data encapsulated within the DSP packets are parsed, as shown at 2310. If there are no errors and/or missing data, then the “no” branch from 2312 will be followed and IP datagrams will be forwarded to a terminal, as shown at 2316.

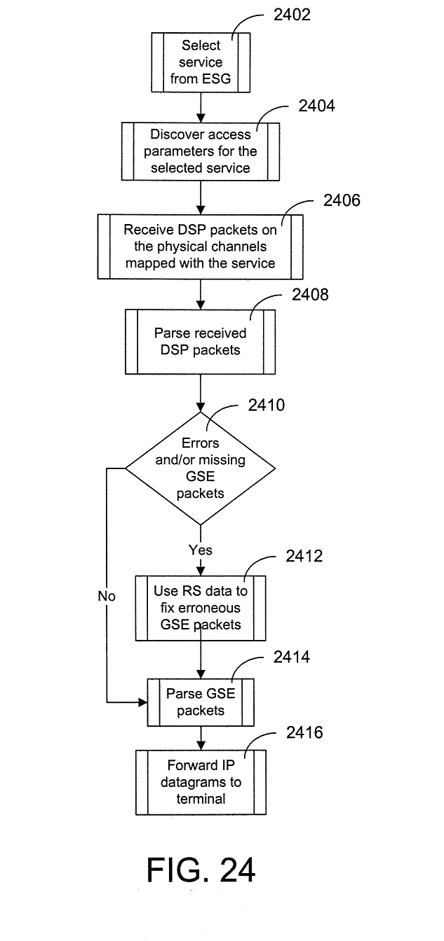

FIG. 24 shows steps performed by a receiver for processing received DSP packets of the type shown in FIG. 20, in accordance with one or more aspects of the invention. A service is selected from an ESG, as shown at 2402. Access parameters, such as access parameters of an SDD and/or an NSDD, for the selected service are discovered, as shown at 2404. DSP packets are received on the physical channels mapped with the service, as shown at 2406. The received DSP packets are parsed, as shown at 2408. If there are one or more errors and/or missing GSE packets, then the “yes” branch from 2410 will be followed and RS data will be used to fix erroneous GSE packets, as shown at 2412. Then, and if there are no errors and/or missing GSE packets, then the “no” branch from 2410 will be followed and, GSE packets with matching logical channel identifiers are parsed, as shown at 2414. And IP datagrams are forwarded to a terminal, as shown at 2416.

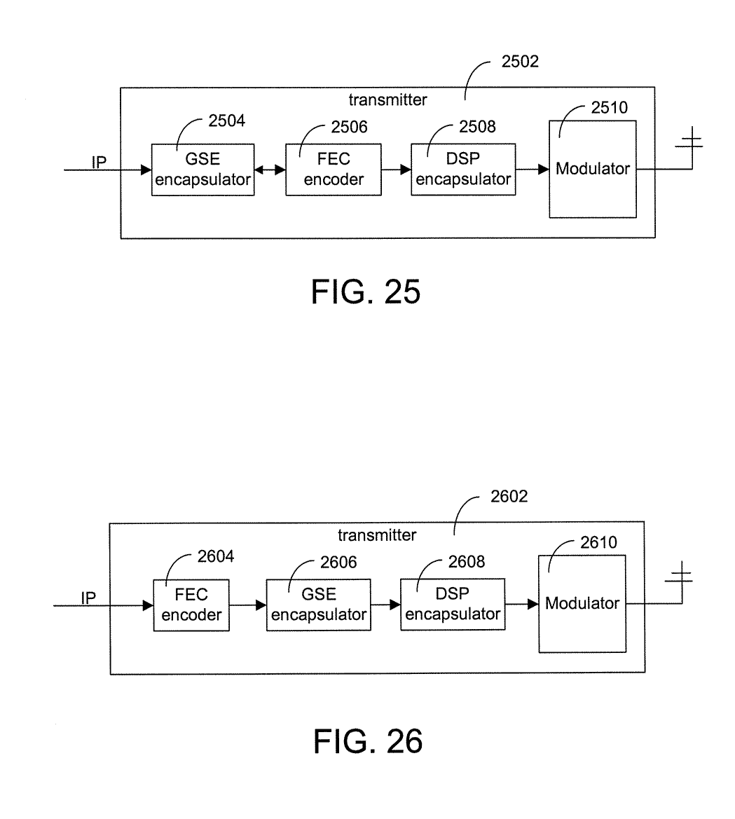

FIG. 25 is a schematic diagram of system components of a transmitter 2502 in accordance with aspects of the invention. In accordance with an embodiment, GSE encapsulator 2504 encapsulates IP data into separate GSE packets. FEC encoder 2506 calculates RS parity data and provides GSE packets and RS data to DSP encapsulator 2508, which encapsulates GSE packets and RS data into DSP packets. Modulator 2510 schedules the DSP packets into transmission frame slots.

In accordance with a different embodiment, GSE encapsulator 2504 encapsulates IP data and RS data into separate GSE packets. If FEC encoding has not already been performed for the GSE packets, then FEC encoder 2506 calculates RS parity data and provides FEC encoded packets to DSP encapsulator 2508 and provides RS data to GSE encapsulation 2504. DSP encapsulator 2508 encapsulates FEC encoded GSE packets into DSP packets, and modulator 2510 schedules the DSP packets into transmission frame slots.

FIG. 26 is a schematic diagram of a transmitter 2602 in accordance with aspects of the invention. In accordance with an embodiment, FEC encoder 2604 calculates RS parity data and provides IP datagrams and RS data to GSE encapsulator 2606, which encapsulates IP data and RS data into separate GSE packets. DSP encapsulator 2608 encapsulates the GSE packets into DSP packets, and modulator 2610 schedules the DSP packets into transmission frame slots.

In a different embodiment, FEC encoder 2604 calculates RS parity data and provides IP datagrams and RS data to GSE encapsulator 2606, which encapsulates IP data into GSE packets. DSP encapsulator 2608 encapsulates GSE packets and RS data into DSP packets, and modulator 2610 schedules the DSP packets into transmission frame slots.

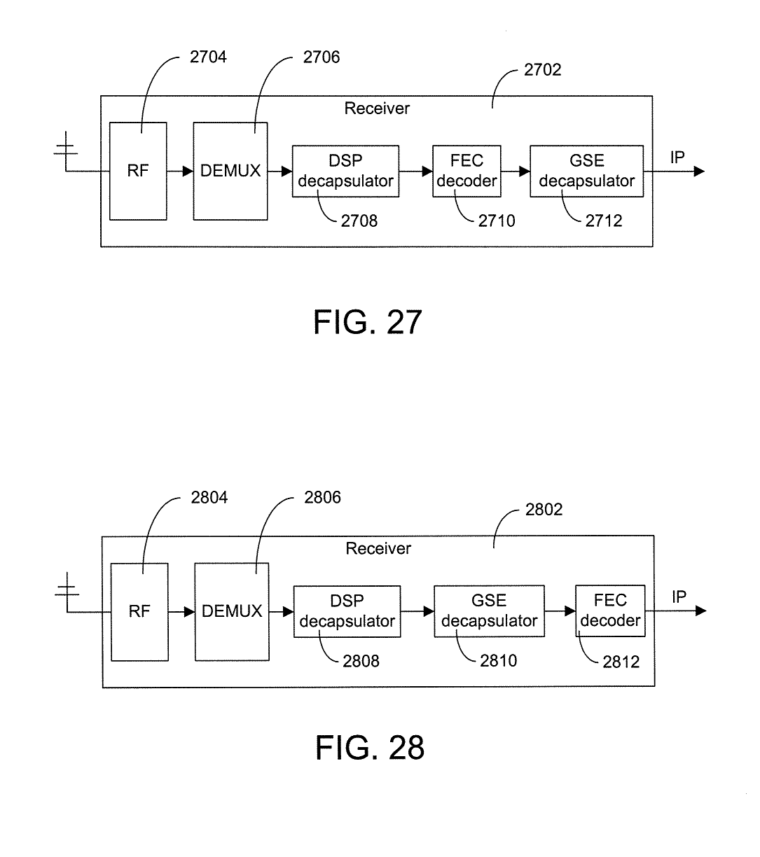

FIG. 27 is a schematic diagram of a receiver 2702 in accordance with aspects of the invention. In one embodiment, RF part 2704 and demultiplexer 2706 provide received DSP packets to DSP decapsulator 2708, which decapsulates the DSP packets and RS data encapsulated with the DSP packets. FEC decoder 2710 determines whether the decapsulated DSP packets contain any errors or are missing any data. If there are any errors, and/or there is any missing data, FEC decoder 2710 uses RS data to fix the errors and/or missing data. GSE decapsulator 2712 then forwards IP datagrams to a terminal.

In a different embodiment, RF part 2704 and demultiplexer 2706 provide received DSP packets to DSP decapsulator 2708, which decapsulates the DSP packets. FEC decoder 2710 determines whether the decapsulated DSP packets contain any errors or are missing any data. If there are any errors, and/or there is any missing data, FEC decoder 2710 uses RS data to fix the errors and/or missing data. GSE decapsulator 2712 then forwards IP datagrams to a terminal.

FIG. 28 is a schematic diagram of a receiver 2802 in accordance with aspects of the invention. RF part 2804 and demultiplexer 2806 provide received DSP packets to DSP decapsulator 2808, which decapsulates the DSP packets. GSE decapsulator 2810 decapsulates GSE packets encapsulated within the DSP packets. FEC decoder 2812 determines whether there are any errors, or there is any missing data, in the decapsulated GSE packets. If there are one or more errors and/or missing data, then the FEC decoder 2812 may use the RS data to fix the erroneous and/or missing data. If there are no errors and/or missing data, or once any errors and/or missing data has been corrected, FEC decoder 2812 forwards IP datagrams to a terminal.

The error correaction code described within the examples discussed above is Reed Solomon (RS), but, as will be apparent, any other suitable code could also be used, such as Low-Density Parity-Check (LDPC) code.

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), application specific integrated circuits (ASIC) and the like.

Embodiments of the invention include any novel feature or combination of features disclosed herein either explicitly or any generalization thereof. While embodiments of the invention have been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A method comprising:
calculating error correaction data based on application data-carrying datagrams;
encapsulating the application data-carrying datagrams and the calculated error correaction data into generic stream encapsulation packets;
encapsulating the generic stream encapsulation packets into data stream protocol packets; and
scheduling the data stream packets into transmission frame slots.

2. The method of claim 1, wherein the application data-carrying datagrams are Internet Protocol datagrams and the error correaction data is Reed-Solomon data.

3. The method of claim 1, wherein the application data-carrying datagrams are Internet Protocol datagrams and the error correaction data is low density parity check data.

4. A method comprising:
encapsulating application data-carrying datagrams into generic stream encapsulation packets;
calculating error correaction data based on the generic stream encapsulation packets;
encapsulating the generic stream encapsulation packets and the error correaction data into data stream protocol packets; and
scheduling the data stream protocol packets into transmission frame slots.

5. The method of claim 4, wherein the application data-carrying datagrams are Internet Protocol datagrams and the error correaction data is Reed-Solomon data.

6. The method of claim 4, wherein the application data-carrying datagrams are Internet Protocol datagrams and the error correaction data is low density parity check data.

7. A method comprising:
encapsulating application data-carrying datagrams and error correaction data into generic stream encapsulation packets;
calculating additional error correaction data based on the generic stream encapsulation packets and making the additional error correaction data available for encapsulation into additional generic stream encapsulation packets;
encapsulating generic stream encapsulation packets into data stream protocol packets; and
scheduling the data stream protocol packets into transmission frame slots.

8. The method of claim 7, wherein the application data-carrying datagrams are Internet Protocol datagrams and the error correaction data is Reed-Solomon data.

9. The method of claim 7, wherein the application data-carrying datagrams are Internet Protocol datagrams and the error correaction data is low density parity check data.

10. A method comprising:
calculating error correaction data based on application data-carrying datagrams;
encapsulating the application data-carrying datagrams into generic stream encapsulation packets;
encapsulating the generic stream encapsulation packets and the error correaction data into data stream encapsulation packets; and
scheduling the data stream encapsulation packets into slots of the transmission frames.

11. The method of claim 10, wherein the application data-carrying datagrams are Internet Protocol datagrams and the error correaction data is Reed-Solomon data.

12. The method of claim 10, wherein the application data-carrying datagrams are Internet Protocol datagrams and the error correaction data is low density parity check data.

13. A method comprising:
receiving data stream protocol packets;
parsing the received data stream protocol packets;
parsing generic stream encapsulation packets encapsulated within the data stream protocol packets; and
if the generic stream encapsulation packets contain errors and/or are missing data, using error correaction data from the data stream protocol packets to correct the errors and/or replace the missing data.

14. The method of claim 13, further comprising: parsing error correaction data encapsulated within the generic stream encapsulation packets.

15. The method of claim 13, wherein the error correaction data is Reed-Solomon data.

16. The method of claim 13, wherein the error correaction data is low density parity check data.

17. The method of claim 13, further comprising: if the data stream protocol packets are missing generic stream encapsulation packets, using error correaction data from the generic stream encapsulation packets to replace the missing generic stream encapsulation packets

18. A system comprising:
a transmitter containing a generic stream encapsulation encapsulator, a forward error correaction encoder, and a data stream protocol encapsulator and configured to receive application data and to transmit data stream protocol packets; and
a receiver containing a data stream protocol decapsulator, a generic stream encapsulation decapsulator, and a forward error correaction decoder and configured to receive the transmitted data stream protocol packets.

19. The system of claim 18, wherein the data stream protocol packets contain error correaction data calculated by the forward error correcting encoder over application data.

20. The system of claim 18, wherein the data stream packets contain error correaction data calculated by the forward error correcting encoder over generic stream encapsulation packets.

21. The system of claim 18, wherein the data stream protocol packets contain generic stream encapsulation packets that encapsulate error correaction data.

22. The system of claim 18, wherein the data stream packets contain generic stream encapsulation packets and error correaction data calculated over application data packets.

23. An apparatus having a computer readable medium that contains computer executable instructions for causing the apparatus to perform operations comprising:
calculating error correaction data based on application data-carrying datagrams;
encapsulating the application data-carrying datagrams and the calculated error correaction data into generic stream encapsulation packets;
encapsulating generic stream encapsulation packets into data stream protocol packets; and
scheduling data stream packets into transmission frame slots.

24. The apparatus of claim 23, wherein the application data-carrying datagrams are Internet Protocol datagrams and the error correaction data is Reed-Solomon data.

25. The apparatus of claim 23, wherein the application data-carrying datagrams are Internet Protocol datagrams and the error correaction data is low density parity check data.

26. An apparatus having a computer readable medium that contains computer executable instructions for causing the apparatus to perform operations comprising:
encapsulating application data-carrying datagrams into generic stream encapsulation packets;
calculating error correaction data based on the generic stream encapsulation packets;
encapsulating the generic stream encapsulation packets and the error correaction data into data stream protocol packets; and
scheduling the data stream protocol packets into transmission frame slots.

27. The apparatus of claim 26, wherein the application data-carrying datagrams are Internet Protocol datagrams and the error correaction data is Reed-Solomon data.

28. The apparatus of claim 26, wherein the application data-carrying datagrams are Internet Protocol datagrams and the error correaction data is low density parity check data.

29. An apparatus having a computer readable medium that contains computer executable instructions for causing the apparatus to perform operations comprising:
encapsulating application data-carrying datagrams and error correaction data into generic stream encapsulation packets;
calculating additional error correaction data based on the generic stream encapsulation packets and making the additional error correaction data available for encapsulation into additional generic stream encapsulation packets;
encapsulating generic stream encapsulation packets into data stream protocol packets; and
scheduling the data stream protocol packets into transmission frame slots.

30. The apparatus of claim 29, wherein the application data-carrying datagrams are Internet Protocol datagrams and the error correaction data is Reed-Solomon data.

31. The apparatus of claim 29, wherein the application data-carrying datagrams are Internet Protocol datagrams and the error correaction data is low density parity check data.

32. An apparatus having a computer readable medium that contains computer executable instructions for causing the apparatus to perform operations comprising:
calculating error correaction data based on application data-carrying datagrams;
encapsulating application data-carrying datagrams into generic stream encapsulation packets;
encapsulating the generic stream encapsulation packets and the error correaction data into data stream encapsulation packets; and
scheduling the data stream encapsulation packets into slots of the transmission frames.

33. The apparatus of claim 32, wherein the application data-carrying datagrams are Internet Protocol datagrams and the error correaction data is Reed-Solomon data.

34. The apparatus of claim 32, wherein the application data-carrying datagrams are Internet Protocol datagrams and the error correaction data is low density parity check data.

35. An apparatus having a computer readable medium that contains computer executable instructions for causing the apparatus to perform operations comprising:
receiving data stream protocol packets;
parsing the received data stream protocol packets;
parsing generic stream encapsulation packets encapsulated within the data stream protocol packets; and
if the generic stream encapsulation packets contain errors and/or are missing data, using error correaction data from the data stream protocol packets to correct the errors and/or replace the missing data.

36. The apparatus of claim 35, wherein the computer readable medium contains further computer executable instructions for causing the apparatus to perform operations comprising: parsing error correaction data encapsulated within the generic stream encapsulation packets.

37. The apparatus of claim 35, wherein the error correaction data is Reed-Solomon data.

38. The apparatus of claim 35, wherein the error correaction data is low density parity check data.

39. The apparatus of claim 35, wherein the computer readable medium contains further computer executable instructions for causing the apparatus to perform operations comprising: if the data stream protocol packets are missing generic stream encapsulation packets, using error correaction data from the generic stream encapsulation packets to replace the missing generic stream encapsulation packets
